(19) United States
(12) Patent Application Publication
(10) Pub. No.: US 2008/0164819 A1
(43) Pub. Date: Jul. 10, 2008

(54) Semiconductor apparatus using ion beam

(75) Inventors: Sung-Wook Hwang, Seoul (KR); Yung Hee Yvette Lee, Seoul (KR); Chul-Ho Shin, Yongin-si (KR); Jin-Seok Lee, Seoul (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/007,187

(22) Filed: Jan. 8, 2008

(30) Foreign Application Priority Data
Jan. 8, 2007 (KR) 10-2007-002098

(51) Int. Cl. G21K 1/00; H05H 1/00; G21K 1/14

(52) U.S. Cl. 315/111.41; 250/251; 250/492.2

(57) ABSTRACT

Provided is a semiconductor apparatus using an ion beam. The semiconductor apparatus may include a first grid to which a voltage applied. The voltage applied to the first grid may have the same potential level as that of a reference voltage applied to a wall portion of a plasma chamber in which plasma may be generated. The first grid may adjoin the plasma. Therefore, a potential level difference between the first grid and the wall portion of the plasma chamber may be zero, and thus the plasma may be stable.

### PRIORITY STATEMENT

This U.S. non-provisional patent application claims priority under 35 U.S.C. §119 to Korean Patent Application No. 10-2007-0002098, filed on Jan. 8, 2007, in the Korean Intellectual Property Office the entire contents of which are hereby incorporated by reference.

### BACKGROUND

1. Field

Example embodiments disclosed herein relate to a semiconductor apparatus for fabricating a semiconductor device, for example, a semiconductor apparatus using ion beams for semiconductor device fabrication.

2. Description of the Related Art

Semiconductor apparatuses may be used for various semiconductor manufacturing processes. For example, the semiconductor apparatuses may be used for material layer or substrate etching, oxidation, nitriding, dopant ion implantation, or surface treatment.

In general, a semiconductor apparatus using ion beams includes first and second grids and a chamber in which plasma may be generated. The first grid may be relatively close to the plasma, and the second grid may be relatively distant from the plasma. For example, the second grid may be close to a semiconductor substrate to be processed. A relatively highly positive potential may be applied to the first grid, and a ground potential may be applied to the second grid. Owing to the potential difference between the first and second grids, ion beams formed by positive plasma ions in the chamber may run from the first grid to the semiconductor substrate through the second grid.

However, such a semiconductor apparatus has limitations. For example, because a ground potential may generally be applied to a wall of the chamber, the electric potential of the plasma inside the chamber may be increased by the highly positive potential applied to the first grid. Therefore, the plasma may become unstable due to, for example, variations in the potential difference between the wall of the chamber and the first grid. As a result, sputtering may occur on the wall of the chamber by ions of the plasma, or ion beam fluctuation or arching may occur, resulting in a defective manufacture of semiconductor devices. In addition, because precise adjustment may be required for the semiconductor apparatus to address such limitations, a process window reduces.

### SUMMARY

Example embodiments provide a semiconductor apparatus using an ion beam while keeping plasma stable. Example embodiments also provide a semiconductor apparatus capable of inducing an ion beam having a sufficient energy level while keeping plasma stable.

Example embodiments provide semiconductor apparatuses including a plasma chamber including a wall portion to which a reference voltage may be applied and an inner space in which plasma may be generated and a plurality of grids adjacent to the plasma chamber inducing ion beams from the plasma. Each of the grids may include a plurality of induction holes through which ion beams may pass. A voltage having the same potential level as that of the reference voltage may be applied to a first grid of the plurality of grids closest to the plasma, and a voltage having a potential level different from that of the reference voltage is applied to a last grid of the plurality of grids farthest from the plasma.

Because a voltage applied to the first grid may have the same potential level as that of the reference voltage, the stability of the plasma may not be affected by a potential difference between the first grid and the wall portion of the plasma chamber. In addition, because a voltage applied to the last grid may have a potential level different from that of the reference voltage, energy corresponding to a potential level difference between the first and last grids may be supplied to the ion beams.

In example embodiments, the ion beams may be positive ion beams. The voltage applied to the last grid may have a potential level lower than that of the reference voltage. The plurality of grids may include at least one grid as a flux adjustment grid disposed between the first and last grids. A voltage having a potential level lower than that of the reference voltage may be applied to the flux adjustment grid. The voltage applied to the flux adjustment grid may have a potential level lower than that of the voltage applied to the last grid.

In other example embodiments, the ion beams may be negative ion beams. The voltage applied to the last grid may have a potential level higher than that of the reference voltage. The plurality of grids may include at least one grid as a flux adjustment grid between the first and last grids. A voltage having a potential level higher than that of the reference voltage may be applied to the flux adjustment grid. The voltage applied to the flux adjustment grid may have a potential level higher than that of the voltage applied to the last grid.

In still other example embodiments, the semiconductor apparatus may further include a neutralizing unit for converting the ion beams into neutral beams. The plurality of grids may be disposed between the plasma chamber and the neutralizing unit. A voltage having the same potential level as that of the voltage applied to the last grid may be applied to the neutralizing unit. The neutralizing unit may include a plurality of reflection plates positioning with an angle to the ion beams. Alternatively, the neutralizing unit may include a plate through which a plurality of penetration holes may be formed. The ion beams may be converted into neutral beams while passing through the penetration holes. The penetration holes of the neutralizing unit may be aligned with the induction holes of the grids. The penetration holes may have an aspect ratio greater than that of the induction holes.

In even other example embodiments, the wall portion of the plasma chamber may include an outer wall that may be formed of a conductive material and an inner wall that may be on the outer wall and may be formed of a dielectric material. The inner wall may adjoin the inner space of the plasma chamber, and the reference voltage may be applied to the outer wall. In yet other example embodiments, the reference voltage may have a ground potential level.

### BRIEF DESCRIPTION OF THE FIGURES

The accompanying figures are included to provide a further understanding of the example embodiments, and are incorporated in and constitute a part of this specification. The drawings illustrate example embodiments of the semiconductor apparatus and, together with the description, serve to explain principles of the example embodiments. In the figures:

FIG. 1 is a schematic depiction of a semiconductor apparatus according to example embodiments;

FIG. 2 is an enlarged view illustrating portion A of FIG. 1;

FIG. 3 is a graph illustrating voltages supplied to a plasma chamber, a neutralizing unit, and grids in the case where ions of ion beams are positive ions;

FIG. 4 is a graph illustrating voltages supplied to a plasma chamber, a neutralizing unit, and grids in the case where ions of ion beams are negative ions; and

FIG. 5 is a schematic depiction of a semiconductor apparatus according to example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. In particular, the relative dimension or positioning of elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Example embodiments are described more fully hereinafter with reference to the accompanying drawings, in which example embodiments are shown. Example embodiments may, however, be embodied in many different forms and should not be construed as limited to the example embodiments set forth herein. Rather, these embodiments are provided so that this disclosure will be thorough and complete, and will fully convey the scope of example embodiments to those skilled in the art. In the drawings, the size and relative sizes of layers and regions may be exaggerated for clarity.

It will be understood that when an element is referred to as being “on,” “connected to” or “coupled to” another element and the like, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments will be described below in more detail with reference to the accompanying drawings. Example embodiments may, however, be in different forms and should not be constructed as limited to the embodiments set forth herein. Rather, these embodiments are provided so that this disclosure will be thorough and complete, and will fully convey the scope of example embodiments to those skilled in the art. Like reference numerals refer to like elements throughout.

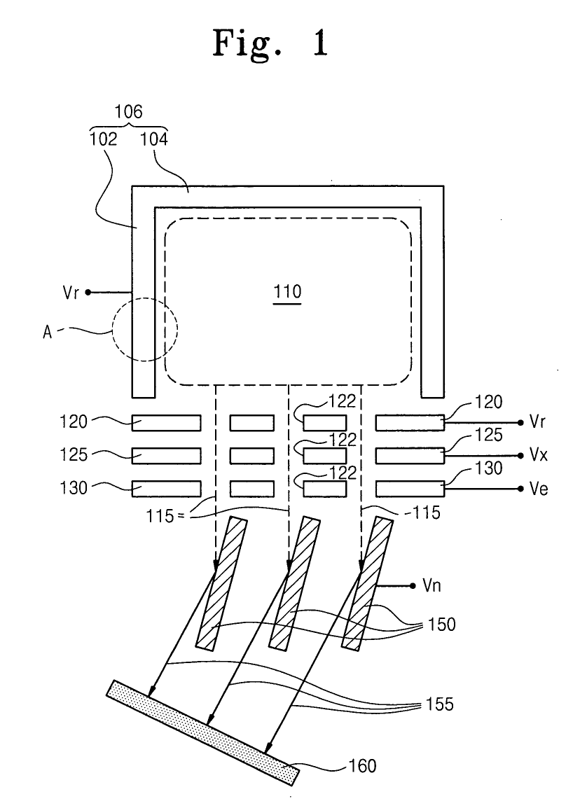

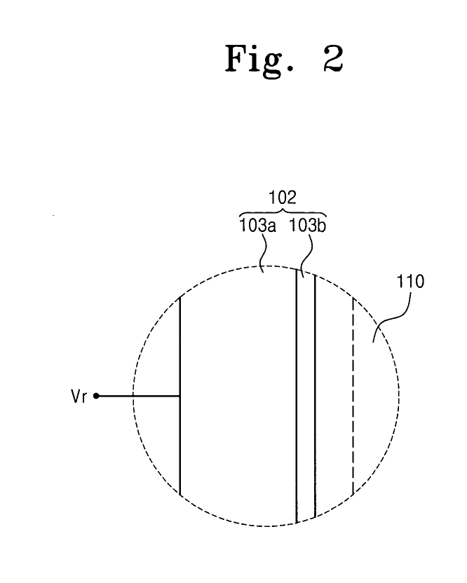

FIG. 1 is a schematic depiction of a semiconductor apparatus according to an example embodiment, and FIG. 2 is an enlarged view illustrating portion A of FIG. 1. Referring to FIGS. 1 and 2, the semiconductor apparatus may include a plasma chamber 106. The plasma chamber 106 may include a wall portion 102 and a cover portion 104 that enclose an inner space, wherein plasma 110 may be generated. The wall portion 102 may include an outer wall 103a and an inner wall 103b. The wall portion 102 may entirely be formed of a conductive material, a metal, for example. Alternatively, the outer wall 103a may be formed of a conductive material but the inner wall 103b may be formed of a dielectric material, so that the plasma 110 may float away from the outer wall 103a.

A reference voltage Vr may be applied to the outer wall 103a. The reference voltage Vr may also be applied to the cover portion 104 if the cover portion 104 includes a conductive material. The reference voltage Vr may not be applied to the cover portion 104 if the cover portion 104 is formed of a dielectric material.

The process gas may be supplied to the inner space of the plasma chamber 106 through a gas injection pipe (not shown) passing through the wall portion 102 and be converted into the plasma 110 therein by a plasma generator (not shown). Mounted on the plasma chamber, the plasma generator 106 may be a coil wound around the wall portion 102 or a coil disposed on the cover portion 104. In the latter case, the cover portion 104 may be formed of a dielectric material.

The semiconductor apparatus may further include a plurality of grids 120, 125, and 130 for inducing ion beams from the plasma 110. Each of the grids 120, 125, and 130 may be a conductive plate of, for example, a disk shape or any other shapes applicable. The grids 120, 125, and 130 may be sequentially arranged from the plasma chamber 106. The grid 120 may be closest to the plasma chamber 106, and therefore will be referred to as a first grid 120 hereinafter. The grid 130 may be farthest from the plasma chamber 106, and therefore will be referred to as a last grid 130 hereinafter. The grid 125 may be used to adjust the flux of ion beams. The flux adjustment grid 125, as well as other grids (not shown), may be disposed between the first and the last grids 120 and 130, or may not be disposed between the first and the last grids 120 and 130 in the semiconductor apparatus, depending on the need. Example embodiments will be described using only the first grid 120, the flux adjustment grid 125, and the last grid 130, hereinafter.

The grids 120, 125, and 130 may be spaced apart from each other. An insulating material may be disposed between edges of the grids 120, 125, and 130. In addition, the insulating material may also be disposed between edges of the plasma chamber 106 and the first grid 120.

Each of the grids 120, 125, and 130 may include a plurality of induction holes 122. For example, the induction holes 122 may be formed through the grids 120, 125, and 130. So that the ion beams 115 may induce from the plasma 110 and pass through the induction holes 122, the induction holes 122 in the first grid 120, the flux adjustment grid 125, and the last grid 130 may be corresponding to and aligned to each other.

The plasma chamber 106 may have at least one opening on a portion of a wall of the plasma chamber 106. The opening may be the whole side of a wall opposite to the cover portion 104 of the plasma chamber 106, as shown in FIG. 1, or a plurality of openings on the said wall aligned to the holes 122 of the grids 120, 125, and 130. The at least one opening may be covered by the first grid 120. The overall opened area of the plasma chamber 106 may be determined by the sum of the area of each opening.

To induce ion beams from the plasma 110, the reference voltage Vr may be applied to the first grid 120, and a voltage Ve different from Vr may be applied to the last grid 130, so that an electric field may be introduced between the grids. Ion beams 115 may be induced when ions of plasma 110 are driven to flow from the first grid 120 towards the last grid 130 by the electric field between the two grids. Whether Ve is higher or lower than Vr depends on the positive or negative charges of the ions induced from the plasma. The flux of the ion beams 115 may be adjusted by tuning the potential difference between the flux voltage Vx applied to the flux grid 125 and the reference voltage Vr applied to the first grid 120.

As potential energy transforms into kinetic energy when ions flow through the electric field, the kinetic energy gained to the ion beams equals the difference of their potential energy between the first grid 120 and the last grid 130. For positive ions, the overall energy may be the potential energy plus their initial energy level in the plasma and for negative ions, the overall energy may be the potential energy minus their initial energy level in the plasma.

The semiconductor apparatus may further include a neutralizing unit to neutralize the ion beams 115. The neutralizing unit may be a plurality of reflection plates 150 placed after the sequence of the plurality of grids and may be close to the last grid 130.

The reflection plates 150 may include a conductive material and may have an angle to the ion beams 115. A voltage Vn may be applied to the reflection plates and may have the same potential level as that of the beam voltage Ve applied to the last grid 130, so that the ion beams 115 passing through the last grid 130 are not affected by the voltage Vn of the reflection plates 150. When the ion beams 115 meet and collide with the reflection plates 150, the ion beams 115 may be converted into neutral beams 155. The neutral beams 155 may be made up of electrically neutral particles, and therefore, may not be affected by an electric field generated by applying a voltage Vn to the reflection plates 150 (the neutralizing unit). The neutral beams 155 may be directed to a substrate 160 to perform a desired semiconductor manufacture process, e.g., etching, ion implantation, oxidation, nitriding, and/or substrate treatment. The substrate 160 may be electrically floated, or alternatively, a ground voltage may be applied to the substrate 160.

In the semiconductor apparatus, the same voltage Vr may be applied to the wall portion 102 of the plasma chamber 106 and the first grid 120 closest to the plasma 110. For example, the difference in electric potential between the wall portion 102 and the first grid 120 may be set to be zero to prevent or reduce the instability of plasma 110 caused by the electric potential difference, thereby preventing or reducing errors in semiconductor manufacturing processes and increasing a process window.

The voltages Vr, Vx, Ve, and Vn applied to the reflection plates 150 and the grids 120, 125, and 130 will now be explained with more detail according to the state of the ions of the ion beams 115 with reference to graphs.

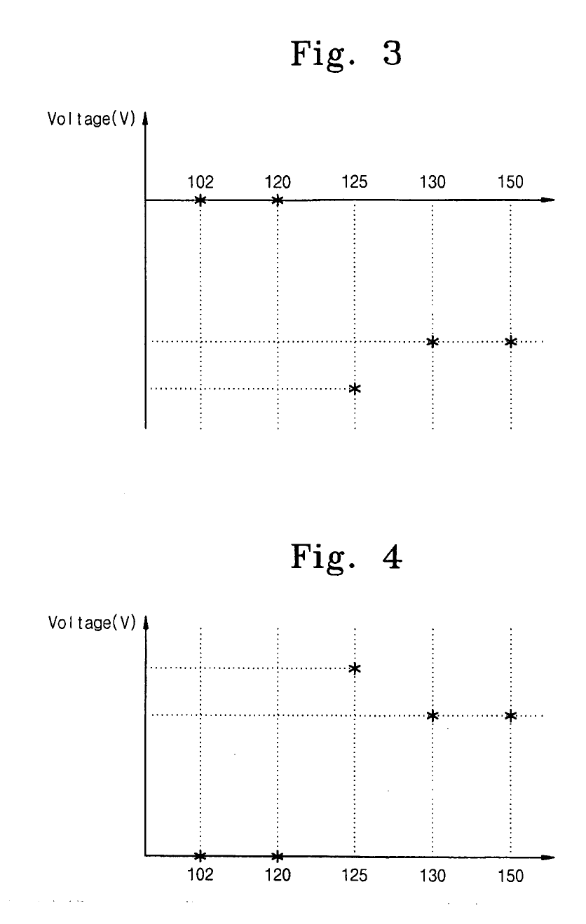

The case where the ions of the ion beams 115 are positive ions will be first explained. FIG. 3 is a graph illustrating the voltages that may be supplied to the neutralizing unit and the grids 120, 125, and 130 when the ions of the ion beams 115 are positive ions. The y-axis is the voltages, and the x-axis is the elements to which the voltages may be applied.

Referring to FIGS. 1, 2, and 3, a reference voltage Vr may be applied to the wall portion 102 and the first grid 120. The reference voltage Vr may be a predetermined or given voltage, for example, a ground voltage. Because positive charges move in an electric field from high potential locations to low potential locations, a beam voltage Ve applied to the last grid 130 may be lower than the reference voltage Vr, as shown in FIG. 3. For example, when the reference voltage Vr has a ground voltage level, the beam voltage Ve may be at a negative voltage level. Therefore, positive ions of the plasma 110 may be forced to move in a direction from the first grid 120 to the last grid 130. As a result, the positive ion beams 115 may be induced from the plasma 110.

The flux of the ion beams 115 may be adjusted by tuning the potential difference between the flux voltage Vx and the reference voltage Vr. The flux voltage Vx may be lower than the reference voltage Vr or/and the beam voltage Ve.

A voltage Vn applied to the reflection plates 150 (the neutralizing unit) may have the same voltage level as that of the beam voltage Ve. Therefore, the ion beams 115 may move from the last grid 130 to the reflection plates 150 without being affected by the voltage Vn applied to the reflection plates 150. Because the voltage Vn applied to the reflection plates 150 has the same voltage level as that of the beam voltage Ve, which is lower than the reference voltage Vr, the positive ions of the ion beams 115, which are not neutralized at the reflection plates 150 may be captured by the reflection plates 150 and receive negative charges. This may form a closed circuit between Vr and Vn. Particles in the ion beams 115 that may be neutralized by the reflection plates 150 may not have extra charges to go into the circuit, therefore may not be captured by the reflection plates 150. As a result, the quality of the neutral beams 155 may be improved.

The case where the ions of the ion beams 115 are negative ions will now be explained. FIG. 4 is a graph illustrating voltages supplied to the neutralizing unit and the grids 120, 125, and 130 when the ions of the ion beams 115 are negative ions. The y-axis is the voltages, and the x-axis is the elements to which the voltages may be applied.

Referring to FIGS. 1, 2, and 4, a reference voltage Vr may be applied to the wall portion 102 and the first grid 120. The potential level of the reference voltage Vr may be the same as that explained in FIG. 3. For example, the reference voltage Vr may have a ground potential level.

Because negative charges move in an electric field from low potential locations to high potential locations, a beam voltage Ve applied to the last grid 130 may be higher than the reference voltage Vr, as shown in FIG. 4. For example, when the reference voltage Vr has a ground potential level, the beam voltage Ve may have a positive potential level. Therefore, negative ions of the plasma 110 may be forced to move in a direction from the first grid 120 to the last grid 130. As a result, the negative ion beams 115 may be induced from the plasma 110.

The flux of the ion beams 115 made up of negative ions may be adjusted by the potential difference between the flux voltage Vx and the reference voltage Vr. The flux voltage Vx may be higher than the reference voltage Vr and/or the beam voltage Ve.

A voltage Vn applied to the reflection plates 150 (the neutralizing unit) may have the same voltage level as that of the beam voltage Ve. Therefore, the ion beams 115 may move from the last grid 130 to the reflection plates 150 without being affected by the voltage Vn applied to the reflection plates 150. Because the voltage Vn applied to the reflection plates 150 may have the same voltage level as that of the beam voltage Ve, which is higher than the reference voltage Vr, the negative ions of the ion beams 115 that are not neutralized at the reflection plates 150 may be captured by the reflection plates 150 and release their negative charges. This may form a closed circuit between Vr and Vn. Particles in the ion beams 115 that may be neutralized may not have extra charges to go into the circuit, therefore may not be captured by the reflection plates 150. As a result, the quality of the neutral beams 155 may be improved.

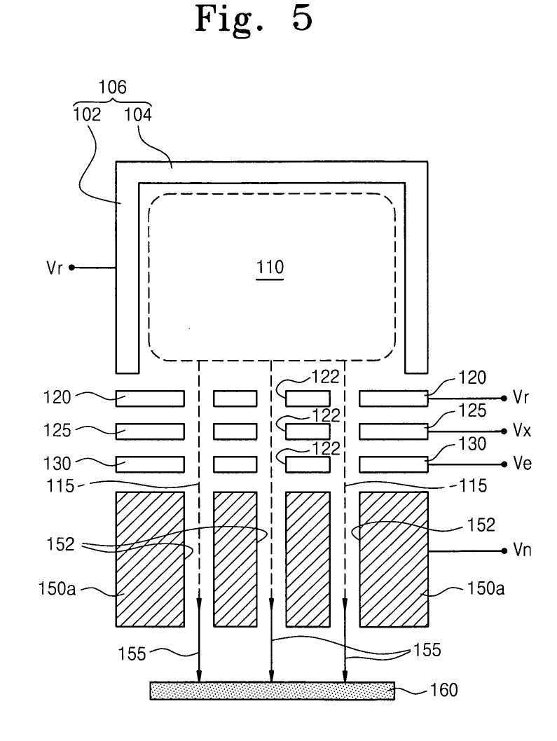

Alternative neutralizing structures other than the reflection plates 150 may also be adopted in the semiconductor apparatus according to example embodiments. FIG. 5 illustrates another semiconductor apparatus according to example embodiments.

Referring to FIG. 5, a plasma chamber 106 and a neutralizing unit 150a may be spaced apart from each other, and a plurality of grids 120, 125, and 130 may be disposed between the plasma chamber 106 and the neutralizing unit 150a. The neutralizing unit 150a may have a plate shape. For example, the neutralizing unit 150a may have a circular disk shape or any other shapes applicable. A plurality of penetration holes 152 may be formed through the neutralizing unit 150a and may correspond to induction holes 122 of the grids 120, 125, and 130. The penetration holes 152 may be aligned with the corresponding induction holes 122. The neutralizing unit 150a may include a conductive material. Similar to that in FIG. 1, a voltage Vn may be applied to the neutralizing unit 150a and may have the same voltage level as that of a beam voltage Ve applied to a last grid 130.

After leaving the last grid 130, ion beams 115 may be neutralized while passing through the penetration holes 152 of the neutralizing unit 150a. The penetration holes 152 may have an aspect ratio greater than that of the induction holes 122. For example, the penetration holes 152 may be long enough for an effective neutralization of ions passing through the penetration holes 152. Furthermore, because the voltage Vn applied to the neutralizing unit 150a may have the same potential level as that of the beam voltage Ve applied to the last grid 130, ions of the ion beams 115 that are not neutralized while passing through the penetration holes 152 may be captured by the neutralizing unit 150a. Therefore, the quality of neutral beams 155 may be improved.

In example embodiments of the semiconductor apparatus, the neutralizing unit may be adopted to convert the ion beams 115 into the neutral beams 155 for performing a predetermined or given semiconductor process. The neutralizing unit may also be removed from the semiconductor apparatus if the ion beams 115 passing through the last grid 130 are directly used for performing a semiconductor process.

As described above, according to example embodiments, a voltage applied to the first grid closest to plasma may have the same potential level as that of a reference voltage applied to the wall portion of the plasma chamber wherein the plasma may be generated. Therefore, a potential level difference between the first grid and the wall portion of the plasma chamber may be zero. As a result, the plasma instability caused by the potential level difference between the first grid and the wall portion of the plasma chamber may be prevented or reduced. In addition, a potential difference between the first and last grid may be used to supply corresponding energy to ion beams in example embodiments of the semiconductor apparatus.

The above-disclosed subject matter is to be considered illustrative, and not restrictive, and the appended claims are intended to cover all such modifications, enhancements, and other embodiments, which fall within the true spirit and scope of example embodiments. Thus, to the maximum extent allowed by law, the scope of example embodiments is to be determined by the broadest permissible interpretation of the following claims and their equivalents, and shall not be restricted or limited by the foregoing detailed description.

What is claimed is:

1. A semiconductor apparatus comprising:
a plasma chamber including a wall portion to which a reference voltage is applied and an inner space in which plasma is generated; and
a plurality of grids adjacent to the plasma chamber inducing ion beams from the plasma, wherein
each of the grids includes a plurality of induction holes through which the ion beams pass,
a voltage having the same potential level as that of the reference voltage applied to a first grid, and
a voltage having a potential level different from that of the reference voltage applied to a last grid; wherein
the first grid is the grid closest to the plasma, and the last grid is the grid farthest from the plasma.

2. The semiconductor apparatus of claim 1, wherein the ion beams are positive ion beams, and the voltage applied to the last grid has a potential level lower than that of the reference voltage.

3. The semiconductor apparatus of claim 2, wherein the plurality of grids includes at least one grid between the first and last grids, and
the at least one grid between the first and the last grids includes a flux adjustment grid, wherein
a voltage having a potential level lower than that of the reference voltage is applied to the flux adjustment grid.

4. The semiconductor apparatus of claim 3, wherein the voltage applied to the flux adjustment grid has a potential level lower than that of the voltage applied to the last grid.

5. The semiconductor apparatus of claim 1, wherein the ion beams are negative ion beams, and the voltage applied to the last grid has a potential level higher than that of the reference voltage.

6. The semiconductor apparatus of claim 5, wherein the plurality of grids includes at least one grid between the first and last grids, and
the at least one grid between the first and the last grids includes a flux adjustment grid, wherein
a voltage having a potential level higher than that of the reference voltage is applied to the flux adjustment grid.

7. The semiconductor apparatus of claim 6, wherein the voltage applied to the flux adjustment grid has a potential level higher than that of the voltage applied to the last grid.

8. The semiconductor apparatus of claim 1, further comprising:
a neutralizing unit for converting the ion beams into neutral beams, wherein the plurality of grids is between the plasma chamber and the neutralizing unit.

9. The semiconductor apparatus of claim 8, wherein a voltage having the same potential level as that of the voltage applied to the last grid is applied to the neutralizing unit.

10. The semiconductor apparatus of claim 8, wherein the neutralizing unit includes a plurality of reflection plates, wherein the plurality of reflection plates having an angle to the ion beams.

11. The semiconductor apparatus of claim 8, wherein the neutralizing unit includes a plate through which a plurality of penetration holes is formed, and the ion beams are converted into neutral beams while passing through the penetration holes.

12. The semiconductor apparatus of claim 11, wherein the plurality of penetration holes of the neutralizing unit is aligned with the induction holes of the plurality of grids, and the penetration holes have an aspect ratio greater than that of the induction holes.

13. The semiconductor apparatus of claim 1, wherein the wall portion of the plasma chamber comprises:
an outer wall formed of a conductive material; and
an inner wall on the outer wall and formed of a dielectric material, wherein
the inner wall adjoins the inner space of the plasma chamber, and the reference voltage is applied to the outer wall.

14. The semiconductor apparatus of claim 1, wherein the reference voltage has a ground potential level.
